(19) United States
(12) Patent Application Publication
(10) Pub. No.: US 2026/0019833 A1
(43) Pub. Date: Jan. 15, 2026

(54) SYSTEM AND METHOD FOR CREATING THEMATIC LAYERS FOR NETWORK ANALYSIS

(71) Applicant: JIO PLATFORMS LIMITED, Ahmedabad (IN)

(72) Inventors: Aayush BHATNAGAR, Navi Mumbai (IN); Pradeep Kumar BHATNAGAR, Navi Mumbai (IN); Sundaresh SANKARAN, Mumbai (IN); Haresh B AMBALIYA, Amreli (IN); Farsana CS, Thrissur (IN); Gaurav GUJAR, Indore (IN); Smitesh DAMDOO, Navi Mumbai (IN); Vikram SINGH, Navi Mumbai (IN)

(73) Assignee: JIO PLATFORMS LIMITED, Ahmedabad (IN)

(21) Appl. No.: 18/992,834

(22) PCT Filed: May 20, 2024
(86) PCT No.: PCT/IN2024/050589

§ 371 Date: Jan. 9, 2025

(30) Foreign Application Priority Data
Jun. 28, 2023 (IN) 202321043367

(51) Int. Cl. H04W 24/02; H04L 41/14; H04L 41/22

(52) U.S. Cl. CPC H04W 24/02; H04L 41/14; H04L 41/22

(57) ABSTRACT

The present disclosure envisages a system (100) and method for creating thematic layers for network analysis. The system (100) allows users to create thematic layers with dynamic data in real-time based on user interaction. The system includes an input unit, a plurality of data sources, and a processing unit. The input unit receives a request from a user. Each data source stores a plurality of information corresponding to a plurality of performance attributes associated with a network. The processing unit is configured to extract information corresponding to the received request and process the extracted information for generating the at least one thematic layer. The system (100) uses the data sources (104), including performance management, site, cells, configuration management, and fault management to create the thematic layers. The user is able to customize the layers to highlight specific data points, adjust color schemes, and incorporate animations for an added impact.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to wireless communications, and specifically to a system and a method for improving network analysis by monitoring and visualizing a network through thematic tools to maintain a problem-free and optimized network.

### DEFINITION

As used in the present disclosure, the following terms are generally intended to have the meaning as set forth below, except to the extent that the context in which they are used to indicate otherwise.

The expression ‘thematic layer’ used hereinafter in the specification refers to a layer or a spatial representation of analyzed data of elements of the same type. Each thematic layer focuses on a specific theme or attribute, such as user density, site category, peak data rate, or any other spatially relevant characteristic. These layers help users understand and explore different aspects of the data/characteristics of a network that they are studying or managing. A map layer can be visually altered to represent its associated data using thematic (theme wise). Thematic layers play a crucial role in creating informative and insightful site maps, enabling users to make informed decisions based on the spatial relationships and patterns within the data.

The expression ‘thematic map’ used hereinafter in the specification refers to a map that contains one or more thematic layers.

These definitions are in addition to those expressed in the art.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Typically, identifying problematic sites or sectors in a specific network area or region requires multiple procedures, such as downloading of real-time data for various Key Performance Indicators (KPIs), parameters, and alarms from different databases. Telecom operators follow the procedures for a prolonged time, and often require using other applications to visualize problematic or issue-causing sites. However, these procedures are time-consuming, error prone, and requires using multiple steps to identify a root cause of network issues.

There is, therefore, a need in the art for an improved mechanism to analyse the network at a site or a sector level, by using a thematic layering approach, to enable precise troubleshooting and problem addressing of the network.

### OBJECTS OF THE PRESENT DISCLOSURE

It is an object of the present disclosure to provide a system and a method for improving network analysis by monitoring and visualizing a network through thematic tools to maintain a problem-free and optimized network.

It is an object of the present disclosure to provide a customized network analysis based on multiple parameters in a single instance.

It is an object of the present disclosure to provide access to different databases and generate analysis on those data in a single frame.

It is an object of the present disclosure to use a thematic problem-solving approach for site analysis leading to an enhanced user experience.

### SUMMARY

The present disclosure discloses a system for generating at least one thematic layer for network performance monitoring and analysis. The system includes an input unit, a plurality of data sources, and a processing unit. The input unit is configured to receive at least one request from a user. Each of the plurality of data sources is configured to store a plurality of information corresponding to a plurality of performance attributes associated with the network. The processing unit is configured to cooperate with the input unit and the plurality of data sources to receive the at least one request and the stored information respectively. The processing unit is configured to extract at least one information corresponding to the received request and to process the extracted information for generating the at least one thematic layer.

In an embodiment, the system includes a display unit is configured to cooperate with the processing unit and is further configured to display the at least one generated thematic layer.

In an embodiment, the plurality of performance attributes includes a cell level attribute, a site level attribute, an end user mute rate, a peak data rate, a peak spectral efficiency, an area traffic capacity, a latency, a connection density, an average spectral efficiency, an energy efficiency, an air fiber connectivity, a mobility interruption time, and a bandwidth.

In an embodiment, the at least one request includes at least one or more of a data source from the plurality of data sources, at least one attribute from the plurality of performance attributes corresponding to the source, and an operator.

In an embodiment, the operator is a relational operator or a user defined operator.

In an embodiment, the user defined operator is a defined range or a distinct value.

In an embodiment, the relational operator is equals to, not equal to, less than or equal to, greater than or equal to, less than, greater than.

In an embodiment, the plurality of data sources includes a performance management source, a site level attributes source, a cell level attributes source, a configuration management source, and a fault management source.

In an embodiment, the user is configured to customize the at least one thematic layer by defining at least one or more of data points, adjusting color schemes associated with the thematic layer, and incorporating animations.

In an embodiment, the network is a 4G network, a 5G network, or a 6G network.

In an embodiment, the input unit is a touch screen or a pointer device.

In an embodiment, the includes a database for storing the at least one generated thematic layer as an image, such that the system is configured to analyze the stored thematic layer for generating at least one pattem, at least one trend, and at least one anomaly related to the network.

The present disclosure discloses a method of generating at least one thematic layer for network performance monitoring and analysis. The method includes receiving, by an input unit, at least one request from a user. The method includes storing, by a plurality of data sources, a plurality of information corresponding to a plurality of performance attributes associated with the network. The method includes receiving, by a processing unit, the at least one request and the stored information. The method includes extracting, by the processing unit, at least one information corresponding to the at least one request and processing the extracted information for generating the at least one thematic layer.

In an embodiment, the method further comprising displaying the at least one generated thematic layer on a display unit.

In an embodiment, the plurality of performance attributes includes a cell level attribute, a site level attribute, an end user mute rate, a peak data rate, a peak spectral efficiency, an area traffic capacity, a latency, a connection density, an average spectral efficiency, an energy efficiency, an air fiber connectivity, a mobility interruption time, and a bandwidth.

In an embodiment, the method further comprising selecting, by the user, a data source from the plurality of data sources, at least one attribute from the plurality of performance attributes corresponding to the selected source, and an operator via the input unit.

The present disclosure discloses a user equipment which is configured to generate at least one thematic layer for network performance monitoring and analysis. The user equipment includes a processor, and a computer readable storage medium storing programming for execution by the processor. The programming includes instructions to receive at least one request from a user. Under the programming instructions, the processor is configured to store a plurality of information corresponding to a plurality of performance attributes associated with a network. Under the programming instructions, the processor is configured to extract at least one information corresponding to the at least one request and process the extracted information for generating the at least one thematic layer.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates a block diagram of a system for generating at least one thematic layer for network performance monitoring and analysis, in accordance with an embodiment of the present disclosure.

FIG. 2 illustrates an exemplary architecture for creating the thematic layers, in accordance with an embodiment of the disclosure.

FIG. 3 illustrates a process flow for creating the thematic layers, in accordance with an embodiment of the disclosure.

FIG. 4A-FIG. 4C illustrate various snapshots with respect to the defined process flow for creating the thematic layers, in accordance with an embodiment of the disclosure.

FIG. 5 illustrates a sample output showing the created thematic layers, in accordance with an embodiment of the disclosure.

FIG. 6 illustrates an example flow diagram for generating at least one thematic layer for network performance monitoring and analysis, in accordance with an embodiment of the present disclosure.

FIG. 7 illustrates an example computer system in which or with which the embodiments of the present disclosure may be implemented.

The foregoing shall be more apparent from the following more detailed description of the disclosure.

### LIST OF REFERENCE NUMERALS

100—System
102—Input Unit
104, 206—A plurality of Data Sources
106—Processing Unit
110—Database
112—Display Unit
710—External Storage Device
720—Bus
730—Main Memory
740—Read Only Memory
750—Mass Storage Device
760—Communication Port
770—Processor

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above. Some of the problems discussed above might not be fully addressed by any of the features described herein. Example embodiments of the present disclosure are described below, as illustrated in various drawings in which like reference numerals refer to the same parts throughout the different drawings.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items. It should be noted that the terms “mobile device”, “user equipment”, “user device”, “communication device”, “device” and similar terms are used interchangeably for the purpose of describing the invention. These terms are not intended to limit the scope of the invention or imply any specific functionality or limitations on the described embodiments. The use of these terms is solely for convenience and clarity of description. The invention is not limited to any particular type of device or equipment, and it should be understood that other equivalent terms or variations thereof may be used interchangeably without departing from the scope of the invention as defined herein.

As used herein, an “electronic device”, or “portable electronic device”, or “user device” or “communication device” or “user equipment” or “device” refers to any electrical, electronic, electromechanical, and computing device. The user device is capable of receiving and/or transmitting one or parameters, performing function/s, communicating with other user devices, and transmitting data to the other user devices. The user equipment may have a processor, a display, a memory, a battery, and an input-means such as a hard keypad and/or a soft keypad. The user equipment may be capable of operating on any radio access technology including but not limited to IP-enabled communication, Zig Bee, Bluetooth, Bluetooth Low Energy, Near Field Communication, Z-Wave, Wi-Fi, Wi-Fi direct, etc. For instance, the user equipment may include, but not limited to, a mobile phone, smartphone, virtual reality (VR) devices, augmented reality (AR) devices, laptop, a general-purpose computer, desktop, personal digital assistant, tablet computer, mainframe computer, or any other device as may be obvious to a person skilled in the art for implementation of the features of the present disclosure.

Further, the user device may also comprise a “processor” or “processing unit” includes processing unit, wherein processor refers to any logic circuitry for processing instructions. The processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor is a hardware processor.

As portable electronic devices and wireless technologies continue to improve and grow in popularity, the advancing wireless technologies for data transfer are also expected to evolve and replace the older generations of technologies. In the field of wireless data communications, the dynamic advancement of various generations of cellular technology are also seen. The development, in this respect, has been incremental in the order of second generation (2G), third generation (3G), fourth generation (4G), and now fifth generation (5G), and more such generations are expected to continue in the forthcoming time. In today's world, where communication and data transmission play an important role, network performance is crucial. Mobile network operators strive to provide their customers with optimal performance, seamless connectivity, and high-quality services.

Traditional methods of analyzing network performance relied on a combination of manual inspections, drive testing, key performance indicators (KPIs), network monitoring tools, field technicians and customer feedback. Although these methods provided valuable insights, they demanded significant time, resources, and manual labour. Drive testing required physically navigating different locations to collect data on network parameters, while KPIs and network monitoring tools provided quantitative measurements on a network-wide scale. On-site field technicians dealt with issues, and customer complaints provided feedback on network problems. However, these methods may not be sufficient to deliver real-time insights, or proactive issue identification.

The present disclosure discloses a system and method for facilitating the creation of thematic layers that can adapt in real-time based on user interactions. The present system utilizes a diverse range of data sources, including performance management (PM), site attributes, cells attributes, configuration management (CM), and fault management (FM). By integrating information from these multiple data sources, the system ensures a comprehensive and nuanced representation of data for users. The system is configured to provide real-time interaction with users, thereby enabling users to actively shape and modify thematic layers as they engage with the system. The system is configured to allow immediate adjustments, align the visual representation of data with according to needs and preferences of users.

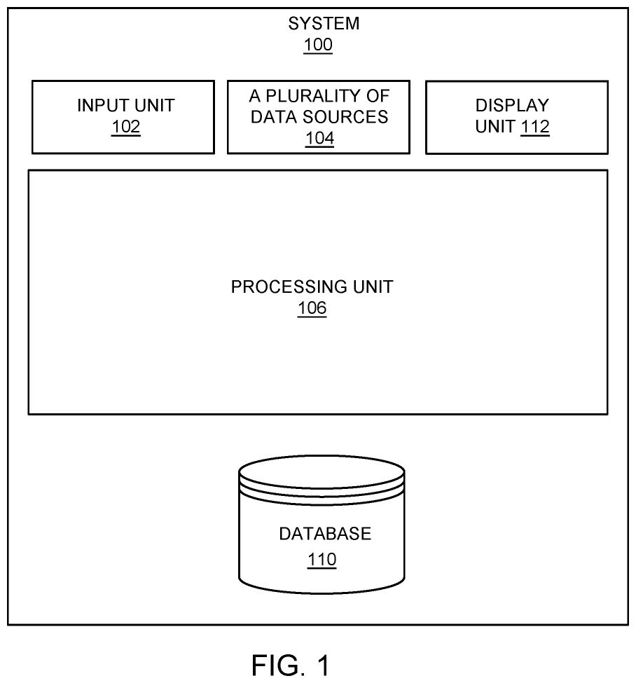

The various embodiments throughout the disclosure will be explained in more detail with reference to FIG. 1-FIG. 7.

FIG. 1 illustrates a block diagram of a system (referred as “system 100”) for generating at least one thematic layer for network performance monitoring and analysis, in accordance with an embodiment of the present disclosure. The user is configured to customize the at least one thematic layer by defining at least one or more of data points, adjusting color schemes associated with the thematic layer, and incorporating animations.

Referring to FIG. 1, the system 100 includes an input unit (102), a plurality of data sources (104), and a processing unit (106). The plurality of data sources (104) is configured to store a plurality of information corresponding to a plurality of performance attributes associated with the network. For example, the plurality of data sources (104) includes a performance management (PM) source, a site level attributes source, a cell level attributes source, a configuration management (CM) source, and a fault management (FM) source. Each of the plurality of data sources (104) stores the plurality of information corresponding to a defined set of performance attributes. For example, the performance management (PM) source is configured to store the information for a performance attribute such as end user mute rate. The end user mute rate is defined as a measurement of calls where calls are getting mute in both direction (called party and calling party). In an example, the plurality of performance attributes a cell level attribute, a site level attribute, an end user mute rate, a peak data rate, a peak spectral efficiency, an area traffic capacity, a latency, a connection density, an average spectral efficiency, an energy efficiency, an air fiber connectivity, a mobility interruption time, and a bandwidth. In an example, the network is a 4G network, a 5G network, or a 6G network. In an aspect, each network has different performance attributes. For example, for 4G network, the system 100 is configured to access a selected data sources such as the performance management (PM) source, the site level attributes source, and the cell level attributes source. Further, for 5G network, the system 100 is configured to access different data sources such as the performance management (PM) source, the site level attributes source, the cell level attributes source, the configuration management (CM) source, and the fault management (FM) source.

The input unit (102) (acting as a user interface) is configured to receive at least one request from a user. In an example, the request includes at least one or more of a data source from the plurality of data sources (104), an attribute from the set of attributes corresponding to the source, and an operator. In an example, the input unit (102) is a touch screen or a pointer device. Using the input unit (102), the user is able to select the data source (for example, the site level attributes source), the attribute from a set of performance attributes (for example, the site priority attribute) corresponding to the selected source, and the operator via the input unit (102). The operator is a relational operator or a user defined operator. In an embodiment, the user defined operator is a defined range or a distinct value. In an example, the relational operator is equals to, not equal to, less than or equal to, greater than or equal to, less than, greater than. In an example, the relational (mathematical) operator is an equality sign (=), an inequality sign (<, >) or the like.

The processing unit (106) is configured to cooperate with the input unit (102) and the plurality of data sources (104) to receive the at least one request and the stored information respectively and is further configured to extract the stored information corresponding to the received request and to process the extracted information based on the received request for generating the thematic layer(s). In an embodiment, the processing unit (106) may be implemented as a combination of hardware and programming (for example, programmable instructions) to implement one or more functionalities of the processing unit (106). In examples described herein, such combinations of hardware and programming may be implemented in several different ways. For example, the programming for the processing unit (106) may be processor-executable instructions stored on a non-transitory machine-readable storage medium and the hardware for the processing unit (106) may comprise a processing resource (for example, one or more processors), to execute such instructions. In the present examples, the machine-readable storage medium may store instructions that, when executed by the processing resource, implement the processing unit (106). In such examples, the system 100 may comprise the machine-readable storage medium storing the instructions and the processing resource to execute the instructions, or the machine-readable storage medium may be separate but accessible to the system 100 and the processing resource. In other examples, the processing unit (106) may be implemented by electronic circuitry. According to an aspect of the present disclosure, the processing unit (106) may be implemented as one or more microprocessors, microcomputers, microcontrollers, digital signal processors, central processing units, state machines, logic circuitries, and/or any devices that manipulate signals based on operational instructions. Among other capabilities, the processing unit may be configured to fetch and execute computer-readable instructions stored in the memory.

In an embodiment, the system 100 includes a display unit 112 which is configured to cooperate with the processing unit and is further configured to display the generated thematic layer.

In an embodiment, one or more computing devices may be connected to the system (100). A person of ordinary skill in the art will understand that the one or more computing devices may be collectively referred as computing devices and individually referred as a computing device. One or more users may provide one or more requests to the system (100). In an embodiment, the computing device may include, but not be limited to, a mobile, a laptop, etc. Further, the computing device may include one or more in-built or externally coupled accessories including, but not limited to, a visual aid device such as a camera, audio aid, microphone, or keyboard. Furthermore, the computing device may include a mobile phone, smartphone, virtual reality (VR) devices, augmented reality (AR) devices, a laptop, a general-purpose computer, a desktop, a personal digital assistant, a tablet computer, and a mainframe computer.

In an embodiment, the network may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system 100 further includes a database 110 for storing the at least one generated thematic layer. The database 110 is configured to store the request received from the user. The database 110 is further configured to store a number of selections made by the user whereas the selection includes at least one or more of a data source from the plurality of sources, an attribute from the set of attributes corresponding to the source, and a mathematical operator. The database 110 is configured to store the generated thematic layer corresponding to the number of selections. In an embodiment, the database is configured to store the at least one generated thematic layer as an image, such that the system is configured to analyze the stored thematic layer for generating at least one pattem, at least one trend, and at least one anomaly related to the network. The database 110 is configured to store computer-readable instructions. The database 110 may be coupled to the processing unit (106) and may include any computer-readable medium known in the art including, for example, volatile memory, such as static random-access memory (SRAM) and dynamic random-access memory (DRAM) and/or non-volatile memory, such as read only memory (ROM), erasable programmable ROM, flash memories, hard disks, optical disks, and magnetic tapes.

Although FIG. 1 shows exemplary components of the system (100), in other embodiments, the system (100) may include fewer components, different components, differently arranged components, or additional functional components than depicted in FIG. 1. Additionally, or alternatively, one or more components of the system (100) may perform functions described as being performed by one or more other components of the system (100).

Using centralized databases and user preference analysis, the system 100 effectively addresses data visualization issues without consuming excessive human work hours. For each Key Performance Indicator (KPI), the system is required to access multiple data sources. However, for evaluating the performance of an area that comprises multiple network sites from different vendors, it is a challenging and time-consuming task to calculate KPIs as different vendors have a specific set of criteria for calculating KPIs. In such cases, generating KPIs from different systems and processing them can be complex, therefore the centralized databases are required for providing an effective solution in such scenario. By centralizing the data, the system is able to bring together information from different sources, making it easier to process and evaluate. This approach helps to reduce the complexity of generating KPIs from multiple systems, and ensures that the data is accurate, reliable, and consistent. Centralized databases also provide a better overview of the performance of the area, enabling the network operators to identify trends and patterns more effectively and helping the network operators to identify areas that require improvement and implement strategies for enhancing performance. By applying the thematic layers approach to the site or sector level, the system 100 effectively troubleshoots and addresses problem in more precise way as all the data is considered at a particular time instance. In addition, backend development efforts are minimized as all the data is analyzed in a single go and the user may visualize thematic analysis. Further, using a thematic plot ensures that the issue is specified towards a particular specific site/cluster. The system 100 enables the user to define the data sources, criteria, and theme color palette. The system 100 is configured to present the generated thematic layer in a single display window, thereby helping engineers (users) to use and perform optimization and performance analysis in a better and effective way.

In an embodiment, the disclosed system 100 facilitates to minimise an effort that is being executed for conducting daily analysis by telecom engineers who retrieve multiple Project Management (PM) Key Performance Indicators (KPIs) or alarm reports to determine root causes of poor network performance faced by customers. In addition, the user may select specific attributes and provide additional criteria along with a thematic preference. With this information, a site layer user interface (UI) may modify with the provided thematic on the sites/sector as user's choice. In an example, a fixed wireless access (FWA) KPIs includes various attributes such as payload, throughput, drop rate, and session success rate. In another example, the Project Management (PM) KPIs includes various attributes such as mute call rate, accessibility, availability, payload, throughput, PRB (Physical Resource Block) utilization etc. In an example, the fixed wireless access (FWA) KPI further include alarm trend as an additional attribute. In another example, the configuration management (CM) source includes attribute such as golden parameters.

In an operative aspect, the disclosed system 100 is used to create the thematic layers with dynamic data in real-time. A network is selected, and a set of data sources based on the determined network is selected. The data sources comprise one of PM source, configuration management (CM) source, Fault Management (FM) source, site level attributes (e.g., site priority, phase, scope, etc.,), cell level attributes (e.g., Physical cell ID (PCI), tracking area code (TAC), Operating Sub-system (OSS)). Further, the plurality of attributes (e.g., accessibility, availability, cell quality index (CQI), alarms, etc.,) are generated based on the data sources. A criteria is applied to identify and visualize sites, cells, and locations which meets the applied criteria. The at least one criterion is given by a user (e.g., user need to identify the sites with call drop rate greater than 2% and accessibility less than 90%). Further, the legends (boolean, ranges, distinct value types, different colours or thematic) are determined according to operators (greater than, less than or equal to, distinct or defined ranges) used in the applied criteria. Next, a date and data granularity are set to fetch the data from the data sources on that particular date. The legends are displayed over the visualized sites, cells, and locations corresponding to the applied criteria based on the data fetched from the data sources.

One of the criteria is that of mathematical operators like “equal to”, “not equal to”, “greater than”, and “less than”. Distinct ranges for unique values in a specified attribute are considered. The ranges are defined where the user may provide and use a set of minimum and maximum values of a specified KPI.

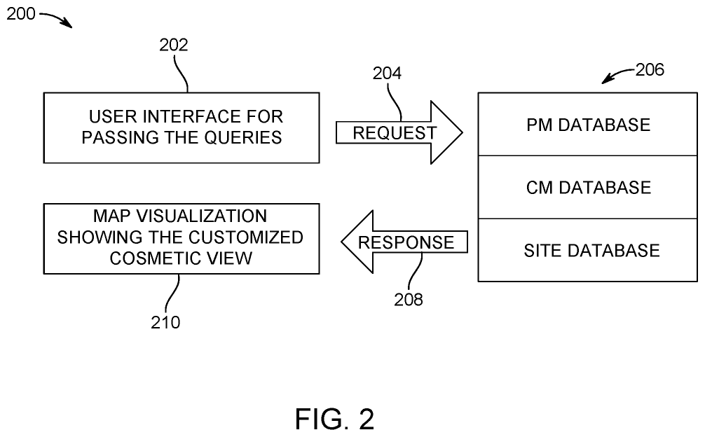

FIG. 2 illustrates an exemplary architecture 200 for creating the thematic layers, in accordance with an embodiment of the disclosure. As shown in FIG. 2, a user interface 202 is used for passing queries, as a request 204. The system 100 is configured to send the request 204 to the plurality of data sources 206 (having a PM database, a CM database, and a site database). The system 100 is configured to retrieve information from the plurality of data sources 206 as a response 208 (thematic layer). Further, the system 100 is configured to display the received response via a map visualization having customized cosmetic views 210 on the user interface. The users are able to use data from various data sources.

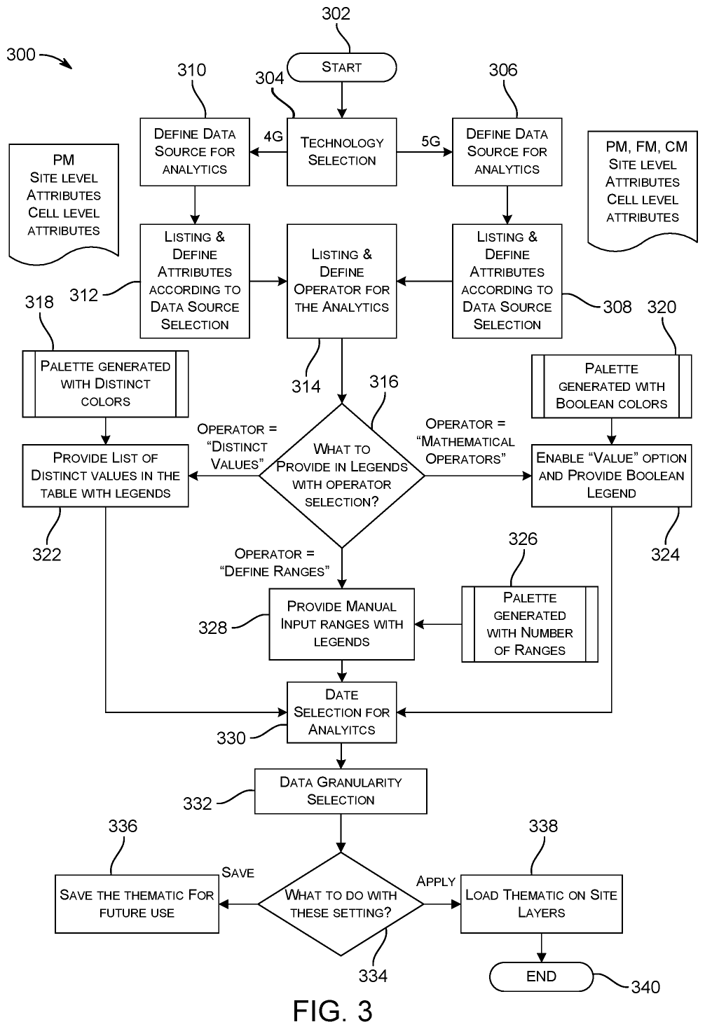

FIG. 3 illustrates a process flow 300 for creating the thematic layers, in accordance with an embodiment of the disclosure. At step 302, the system 100 is ready for receiving input from the user. At step 304, the user is able to select a network (4G or 5G) corresponding to which he wants to generate the thematic layer(s). As is illustrated (step 306), for a 5G technology selection, a data source for analytics is defined. This includes a PM source, FM source, CM source, site level attributes, and cell level attributes. The defined data source is used for listing and defining attributes according to a data source selection (step 308). When the technology section is defined under 4G, a data source for analytics is defined (step 310) and includes parameters such as PM, site level attributes, and cell level attributes. The data source is used for listing and defining attributes according to data source selection (step 312). The defined attributes are used for listing and defining an operator for the analytics (step 314). A decision is made to determine what is to be provided in legends with operator selection (step 316). Further, a palette is generated for distinct colors (step 318). When an operator value is defined as “distinct values”, a list of distinct values is provided in the table with legends (step 322). Further, a palette is generated for boolean colors (step 320). However, when the operator is defined as “mathematical operators” then a “value” option is enabled, and a boolean legend is provided (step 324).

In addition, when the operator is defined as “define ranges” then a manual with input ranges with the legends is provided (step 328). This is supported by a palette generated with a number of ranges (step 326). The enabled values are used for date selection for performing analytics (step 330). The date selection information is passed to a data granularity selection block (step 332). Further, a determination is made with respect to what is to be done with these settings (step 334). One option is to save the thematic for the future use (step 336), and the other option is to select load the thematic of the site layers (step 338). At step 340, the system 100 displays the generated thematic layers.

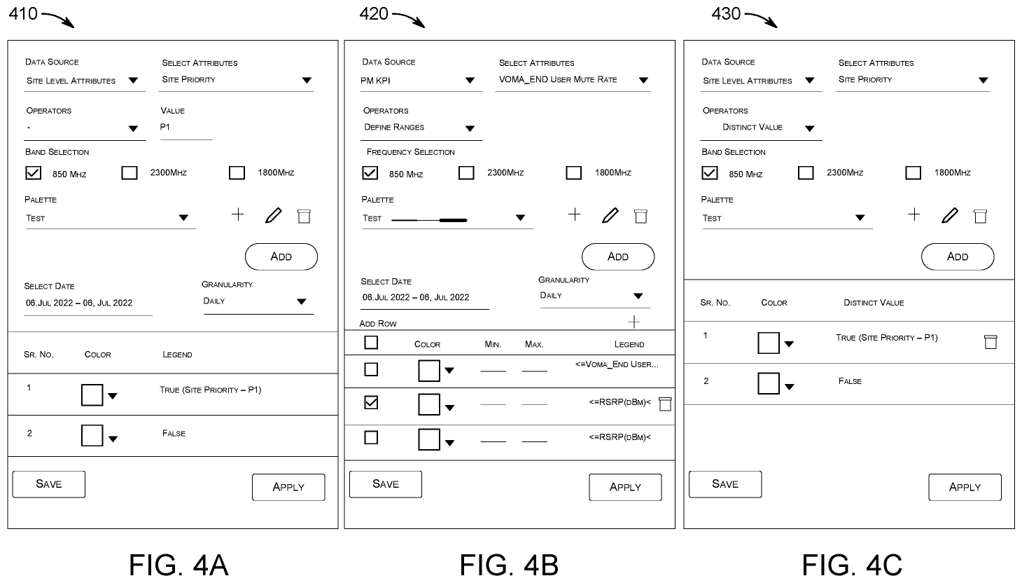

FIG. 4A-FIG. 4C illustrate various snapshots with respect to the defined process flow for creating the thematic layers, in accordance with an embodiment of the disclosure.

FIG. 4A illustrates a snapshot 410 of selecting the data source, attributes corresponding to the selected data source. For example, the selected data source is the site level attributes and selected attribute is site priority. Further, the user is able to select a band and a time duration for which the user wants to generate the thematic layer. By choosing option granularity the user can define the scale or level of detail of data.

FIG. 4B illustrates a snapshot 420 of selecting another data source, attributes corresponding to the selected data source. For example, the selected data source is the PM KPI and selected attribute is user mute rate. Further, the user is able to select an operator (for example defined ranges), and a frequency. The user is able to select various colors to distinguish various information on the thematic layers.

FIG. 4C illustrates another snapshot 430 of selecting another data source, attributes corresponding to the selected data source. For example, the selected data source is the site level attributes and selected attribute is site priority. Further, the user is able to select an operator (for example district values), and a frequency.

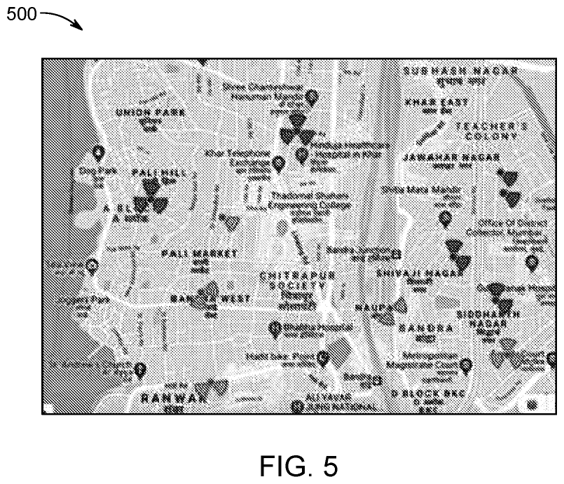

FIG. 5 illustrates a sample output 500 showing the created thematic layer, in accordance with an embodiment of the disclosure.

The disclosed system 100 and method provide a unique network performance monitoring mechanism. In addition, an analysis of the dedicated site or the specific area is provided using the thematic views. The disclosed system 100 and method are a fast and robust troubleshooting mechanism, where performance of the network is enhanced with minimum effort. Due to incorporation of the multiple data sources, the analysis with various perspectives in a single window may allow performing easy Root Cause Analysis (RCA). In addition, the disclosed system 100 and method enhances layer utilization as the thematic is applied on the layers leading to enhanced user interaction on the site layers there by introducing more end users to a cognitive platform.

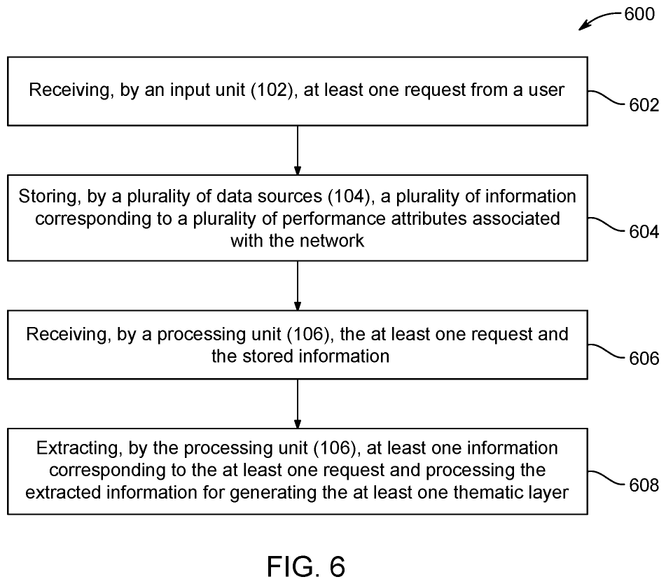

FIG. 6 illustrates an example flow diagram (600) for generating at least one thematic layer for network performance monitoring and analysis, in accordance with an embodiment of the present disclosure.
At step (602), the system (100) receives at least one request from a user using the input unit (102). In an example, the at least one request includes at least one or more of a data source from the plurality of data sources (104), an attribute from the set of attributes corresponding to the source, and a mathematical operator. For example, the plurality of performance attributes includes a cell level attribute, a site level attribute, an end user mute rate, a peak data rate, a peak spectral efficiency, an area traffic capacity, a latency, a connection density, an average spectral efficiency, an energy efficiency, an air fiber connectivity, a mobility interruption time, and a bandwidth. In an example, the cell level attribute is a physical cell identifier. In an example, the site level attribute is a site type, a site priority, or a site progress phase.
At step (604), the plurality of data sources (104) is configured to store the plurality of information corresponding to the plurality of performance attributes associated with the network. For example, the plurality of data sources (104) includes a performance management (PM) source, a site level attributes source, a cell level attributes source, a configuration management (CM) source, and a fault management (FM) source. Each of the plurality of data sources (104) stores the plurality of information corresponding to a defined set of performance attributes.
At step (606), the processing unit (106) receives the at least one request from the input unit (102) and the stored information from the plurality of data sources (104) respectively.
At step (608), the processing unit (106) extracts the stored information corresponding to the at least one request and processes the extracted information based on the at least one request for generating the at least one thematic layer.

In an embodiment, the method (600) further includes a step of displaying the at least one generated thematic layer on a display unit.

In an embodiment, the method (600) further includes a step of selecting, by the user, a source from the plurality of data sources (104), an attribute from a set of performance attributes corresponding to the selected source, and a mathematical operator via the input unit (102).

In an embodiment, the method (600) further includes a step of customizing, by the user, the at least one thematic layer by defining data points, adjusting color schemes, and incorporating animations.

In an exemplary embodiment, the present disclosure discloses a user equipment which is configured to generate at least one thematic layer for network performance monitoring and analysis. The user equipment includes a processor, and a computer readable storage medium storing programming instructions for execution by the processor. Under the programming instructions, the processor is configured to receive at least one request from the user. Under the programming instructions, the processor is configured to store a plurality of information corresponding to a plurality of performance attributes associated with a network. Under the programming instructions, the processor is configured to extract at least one information corresponding to the at least one request and process the extracted information for generating the at least one thematic layer.

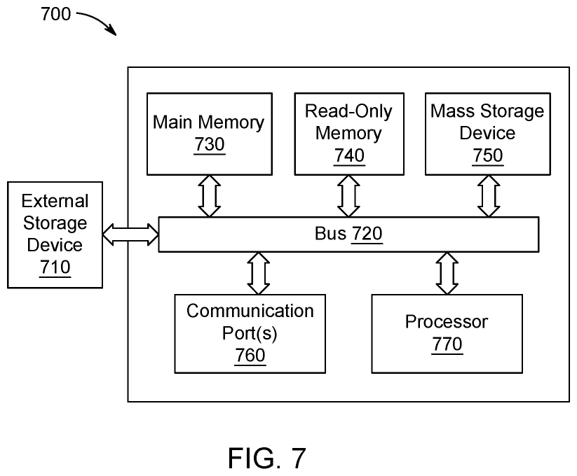

FIG. 7 illustrates an example computer system (700) in which or with which the embodiments of the present system (100) may be implemented.

As shown in FIG. 7, the computer system (700) may include an external storage device (710), a bus (720), a main memory (730), a read-only memory (740), a mass storage device (750), a communication port(s) (760), and a processor (770). A person skilled in the art will appreciate that the computer system (700) may include more than one processor and communication ports. The processor (770) may include various modules associated with embodiments of the present disclosure. The communication port(s) (760) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (760) may be chosen depending on a network, such as a Local Area Network (LAN), Wide Area Network (WAN), or any network to which the computer system connects.

In an embodiment, the main memory (730) may be Random Access Memory (RAM), or any other dynamic storage device commonly known in the art. The read-only memory (740) may be any static storage device(s) e.g., but not limited to, a Programmable Read Only Memory (PROM) chip for storing static information e.g., start-up or basic input/output system (BIOS) instructions for the processor (770). The mass storage device (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (720) may communicatively couple the processor(s) (770) with the other memory, storage, and communication blocks. The bus (720) may be, e.g. a Peripheral Component Interconnect PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor (770) to the computer system (700).

In another embodiment, operator and administrative interfaces, e.g., a display, keyboard, and cursor control device may also be coupled to the bus (720) to support direct operator interaction with the computer system (700). Other operator and administrative interfaces can be provided through network connections connected through the communication port(s) (760). Components described above are meant only to exemplify various possibilities. In no way should the aforementioned exemplary computer system (700) limit the scope of the present disclosure.

The present disclosure is configured to provide an enhanced interactive system which is configured to create thematic layers in real-time by using a combination of various data sources (performance management, configuration management and fault management), based on user interaction. Using the present system, the user is able to customize his thematic layer to highlight specific data points, adjust color schemes, and incorporate animations for adding impact. The present disclosure is applicable to a wide range of applications that require real-time performance tracking of the network cell in real time. With the fast advances of 5G standardization, the present disclosure may be applicable to performance-based services-related use cases.

The method and system of the present disclosure may be implemented in a number of ways. For example, the methods and systems of the present disclosure may be implemented by software, hardware, firmware, or any combination of software, hardware, and firmware. The above-described order for the steps of the method is for illustration only, and the steps of the method of the present disclosure are not limited to the order specifically described above unless specifically stated otherwise. Further, in some embodiments, the present disclosure may also be embodied as programs recorded in a recording medium, the programs including machine-readable instructions for implementing the methods according to the present disclosure. Thus, the present disclosure also covers a recording medium storing a program for executing the method according to the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Present Disclosure

The present disclosure provides a system and a method for improving network analysis by monitoring and visualizing a network through thematic tools to maintain a problem-free and optimized network.

The present disclosure provides customized network analysis based on multiple parameters in a single instance.

The present disclosure provides access to different databases and generates analysis on those data in a single frame.

The present disclosure uses a thematic problem-solving approach for site analysis leading to an enhanced user experience.

1. A system for generating at least one thematic layer for network performance monitoring and analysis, the system comprising:
an input unit configured to receive at least one request from a user;
a plurality of data sources, each of the plurality of data sources is configured to store a plurality of information corresponding to a plurality of performance attributes associated with the network; and
a processing unit configured to cooperate with the input unit and the plurality of data sources to receive the at least one request and the stored information, respectively and is further configured to extract at least one information of the plurality of information corresponding to the received request and to process the extracted information for generating the at least one thematic layer.

2. The system as claimed in claim 1, includes a display unit configured to cooperate with the processing unit and is further configured to display the at least one generated thematic layer.

3. The system as claimed in claim 1, wherein the plurality of performance attributes includes a cell level attribute, a site level attribute, an end user mute rate, a peak data rate, a peak spectral efficiency, an area traffic capacity, a latency, a connection density, an average spectral efficiency, an energy efficiency, an air fiber connectivity, a mobility interruption time, and a bandwidth.

4. The system as claimed in claim 1, wherein the at least one request includes at least one or more of a data source from the plurality of data sources, at least one attribute from the plurality of performance attributes corresponding to the source, and an operator.

5. The system as claimed in claim 4, wherein the operator is a relational operator or a user defined operator.

6. The system as claimed in claim 5, wherein the user defined operator is a defined range or a distinct value.

7. The system as claimed in claim 5, wherein the relational operator is equals to, not equal to, less than or equal to, greater than or equal to, less than, greater than.

8. The system as claimed in claim 1, wherein the plurality of data sources includes a performance management source, a site level attributes source, a cell level attributes source, a configuration management source, and a fault management source.

9. The system as claimed in claim 1, wherein the user is configured to customize the at least one thematic layer by defining at least one or more of data points, adjusting color schemes associated with the at least on thematic layer, and incorporating animations.

10. (canceled)

11. (canceled)

12. The system as claimed in claim 1, further includes a database for storing the at least one generated thematic layer as an image, such that the system is configured to analyze the stored thematic layer for generating at least one pattern, at least one trend, and at least one anomaly related to the network.

13. A method of generating at least one thematic layer for network performance monitoring and analysis, the method comprising:
receiving, by an input unit, at least one request from a user;
storing, by a plurality of data sources, a plurality of information corresponding to a plurality of performance attributes associated with the network;
receiving, by a processing unit, the at least one request and the stored information; and
extracting, by the processing unit, the at least one information of the plurality of information corresponding to the at least one request and processing the extracted information for generating the at least one thematic layer.

14. The method as claimed in claim 13, further comprising displaying the at least one generated thematic layer on a display unit.

15. The method as claimed in claim 13, wherein the plurality of performance attributes includes a cell level attribute, a site level attribute, an end user mute rate, a peak data rate, a peak spectral efficiency, an area traffic capacity, a latency, a connection density, an average spectral efficiency, an energy efficiency, an air fiber connectivity, a mobility interruption time, and a bandwidth.

16. The method as claimed in claim 13, further comprising selecting, by the user, a data source from the plurality of data sources, at least one attribute from the plurality of performance attributes corresponding to the selected source, and an operator via the input unit.

17. A computer program product comprising a non-transitory computer-readable medium comprising instructions that, when executed by one or more processors, cause the one or more processors to:
receive at least one request from a user;
store a plurality of information corresponding to a plurality of performance attributes associated with a network;
extract at least one information from the plurality of information corresponding to the at least one request; and
process the extracted information to generate at least one thematic layer.

18. (canceled)
